(19) United States
(12) Patent Application Publication
(10) Pub. No.: US 2025/0060318 A1
(43) Pub. Date: Feb. 20, 2025

(54) METHODS AND SYSTEMS FOR EVALUATING FIBER QUALITIES

(71) Applicants: Texas Tech University System, Lubbock, TX (US); University of Toledo, Toledo, OH (US)

(72) Inventors: Aniruddha Ray, Toledo, OH (US); Brendan Kelly, Lubboc, TX (US); Hamed Sari-Sarraf, Lubbock, TX (US)

(73) Assignees: Texas Tech University System, Lubbock, TX (US); University of Toledo, Toledo, OH (US)

(21) Appl. No.: 18/723,526

(22) PCT Filed: Dec. 23, 2022
(86) PCT No.: PCT/US2022/053990

§ 371 Date: Jun. 24, 2024

Related U.S. Application Data
(60) Provisional application No. 63/293,448, filed on Dec. 23, 2021.

(51) Int. Cl. G01N 21/88; D06H 3/08; G01N 21/84; G06T 7/00

(52) U.S. Cl. CPC G01N 21/8851; D06H 3/08; G06T 7/0004; G01N 2021/8444; G01N 2021/8854; G01N 2021/8883; G06T 2207/10028; G06T 2207/20084; G06T 2207/30124

(57) ABSTRACT

Embodiments pertain to methods of evaluating fiber quality by (1) receiving at least one in-line hologram image of the fiber; (2) reconstructing the in-line hologram image of the fiber into at least one three-dimensional image of the fiber that includes fiber-related data; and (3) correlating the fiber-related data to fiber quality. Such methods may also include: (4) adjusting fiber-related conditions; and (5) repeating steps 1-3 after the adjustment. Further embodiments pertain to systems for evaluating fiber quality in accordance with the aforementioned methods. Such systems may include a receiving area with a region for housing a fiber, a light source associated with the receiving area, a chamber associated with the light source and receiving area, a camera within the chamber, a processor in electrical communication with the camera, a storage device, an algorithm associated with the storage device and a graphical user interface (GUI) associated with the processor.

### CROSS-REFERENCE TO RELATED APPLICATIONS

This application claims priority to U.S. Provisional Patent Application No. 63/293,448, filed on Dec. 23, 2021. The entirety of the aforementioned application is incorporated herein by reference.

### BACKGROUND

Current methods and systems for assessing fiber quality suffer from numerous limitations, such as high costs, reliance on sophisticated and non-portable equipment, and time-consuming processes. Numerous embodiments of the present disclosure aim to address the aforementioned limitations.

### SUMMARY

In some embodiments, the present disclosure pertains to computer-implemented methods of evaluating fiber quality. In some embodiments, the methods of the present disclosure include: (1) receiving at least one in-line hologram image of the fiber; (2) reconstructing the in-line hologram image of the fiber into at least one three-dimensional image of the fiber that includes fiber-related data; and (3) correlating the fiber-related data to fiber quality. In some embodiments, the methods of the present disclosure also include: (4) adjusting fiber-related conditions; and (5) repeating steps 1-3 after the adjustment.

Additional embodiments of the present disclosure pertain to systems for evaluating fiber quality. In some embodiments, the systems of the present disclosure are operational to evaluate fiber quality in accordance with the methods of the present disclosure. In some embodiments, the systems of the present disclosure are operational to generate at least one in-line hologram image. In some embodiments, the systems of the present disclosure are also operational to reconstruct the in-line hologram image into at least one three-dimensional image of the fiber that includes fiber-related data.

In some embodiments, the systems of the present disclosure include a receiving area with a region for housing a fiber, a light source associated with the receiving area, a chamber associated with the light source and receiving area, a camera within the chamber, a processor in electrical communication with the camera, a storage device, an algorithm stored within the storage device, and a graphical user interface (GUI) associated with the processor. In operation, a fiber to be evaluated is placed on the region of the receiving area. Thereafter, the receiving area is coupled with the chamber and light source. Next, the light source is actuated to irradiate the region such that the camera records an interference between light wave scattered from the fiber and the light source. Thereafter, the recorded interference is transmitted to the processor for generation of an in-line hologram image of the fiber. The processor then reconstructs the in-line hologram image of the fiber into a three-dimensional image of the fiber with fiber-related data. The fiber-related data from the three-dimensional image is then fed into the algorithm for the correlation of the fiber-related data to fiber quality. The graphical user interface (GUI) may be utilized to assist with the evaluation of the fiber quality.

Additional embodiments of the present disclosure pertain to computer program products for evaluating fiber quality. In some embodiments, the computer program product includes one or more computer readable storage mediums having a program code embodied therewith, where the program code includes programming instructions for: receiving at least one in-line hologram image of the fiber; reconstructing the at least one in-line hologram image of the fiber into at least one three-dimensional image of the fiber with fiber-related data; and correlating the fiber-related data to fiber quality. In some embodiments, the program code also includes programming instructions for generating the in-line hologram mage of the fiber.

### DESCRIPTION OF THE DRAWINGS

FIG. 1A illustrates a method of evaluating fiber quality in accordance with various embodiments of the present disclosure.

FIGS. 1B-1C illustrate various aspects of a system for evaluating fiber quality in accordance with various embodiments of the present disclosure.

FIG. 1D provides an illustration of a computer program product for evaluating fiber quality.

FIGS. 2A-2F provide various illustrations of an imaging system for obtaining in-line hologram images of fibers. FIG. 2A provides a planar view of the imaging system, which shows a processor, a camera, and an illumination unit. FIG. 2B shows another view of the imaging system, where the illumination unit is removed. FIG. 2C shows a top view of the imaging system while a sample containing fibers is placed on an imaging chip of the imaging system. FIG. 2D shows a photograph of the sample containing cotton fibers, where the cotton fibers are sandwiched between two glass coverslips. FIG. 2E provides a top view of the processor and connecting wires. FIG. 2F shows a top view of the imaging system's illumination unit while being turned on.

FIG. 3 provides an illustration of an in-line hologram image of a cotton fiber recorded by the imaging chip of the imaging system shown in FIGS. 2A-2F. The in-line hologram image was recorded from an area of more than 10 mm².

FIGS. 4A-4D show reconstructions of in-line hologram images of cotton fibers. FIG. 4A provides a phase reconstructed image of the cotton fibers, where the full field of view is about 10 mm². FIGS. 4B-4D provide zoomed-in images of a section of the cotton fibers at three different heights: top (FIG. 4B), middle (FIG. 4C), and bottom (FIG. 4D). The zoomed-in images illustrate the intricate structures of the cotton fibers, such as the spirals and the cellulose (outer wall).

FIG. 5 shows the launch screen of the “Holo Video Labeler” algorithm for analysis of a reconstructed in-line hologram image of cotton fibers.

FIGS. 6A-6D provide validations of phase reconstructed images of cotton fibers. FIG. 6A shows a phase reconstructed image of the cotton fibers, where the full field of view is ˜10 mm². This area is ˜40 times larger than the field-of-view of a 20× objective. FIG. 6B shows a zoomed-in image of a section of a cotton fiber from the image in FIG. 6A. FIGS. 6C-6D show dark field (FIG. 6C) and phase contrast images (FIG. 6D) of the same fiber area.

FIGS. 7A-7D provide phase reconstructed images of different cotton fibers. FIG. 7A provides a phase reconstructed image of the cotton fibers of a different set of fibers. The full field of view is ˜10 mm². This area is ˜40 times larger than the field-of-view of a 20× objective.

FIG. 7B provides a zoomed-in image of a section of a cotton fiber from the image in FIG. 7A. FIGS. 7C-7D show dark field (FIG. 7C) and phase contrast images (FIG. 7D) of the same fiber area.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in

Assessing the physical features of fibers (often called fiber quality) serves an important purpose in the textile industry. For instance, assessing the physical features of cotton fibers are important to stakeholders across the cotton industry.

Two important fiber quality characteristics are the relative thickening of the secondary cell wall, defined as fiber maturity, and the fineness of the fiber. Fiber maturity affects the ability of the fiber to absorb dye and resist breakage during processing, while the fiber fineness affects the fineness of the yarn that can be produced at the mill. Existing methods for evaluating these fiber properties either do not measure them separately as is needed in many applications, or the method is too slow to be practical for widespread use.

In particular, there are several methods for measuring fiber quality, maturity, and fineness. For instance, a high-volume instrument (HVI) is a primary cotton fiber marketing tool used by the USDA-AMS on domestically produced bales. The HVI does not evaluate maturity and fineness separately. Instead, it uses a laminar flow of air to measure the inverse of the specific surface of a 10 g sample of randomly organized fiber. This measurement is called the Micronaire test. Even though the measurement is fast, it is affected by both maturity and fineness, and neither fiber property can be determined separately using the HVI Micronaire test alone.

Moreover, the costs for the HVI test and corresponding instruments are expensive, with costs of more than $250,000. Additionally, the HVI test requires large stationary laboratory instruments that do not provide a separate measurement of fiber maturity and fineness.

Advanced fiber information system (AFIS) tests provide alternative methods for measuring fiber quality. The AFIS tests are based on individual fiber testing, where fibers are mechanically removed from a loosely packed bundle—called a silver—and brought into a flow of air for presentation to a series of sensors. The light-based sensors are used to measure length, maturity, and fineness of the fibers presented. Maturity and fineness of individual fibers is determined using the reflection of two light sensors, one at 0 degrees and another at 40 degrees.

However, like HVI tests, costs for the AFIS tests and corresponding instruments are also expensive, with costs of more than $250,000. Additionally, AFIS tests require large stationary laboratory instruments that have limited processing capacities. Moreover, AFIS tests require operation by highly skilled technicians.

The Cottonscope provides another method for measuring fiber quality. The Cottonscope is a snippet tester where samples are chopped into 0.7 mm segments and placed in a bowl of water and surfactant. The Cottonscope uses birefringent light and image analysis to determine the maturity of each fiber snippet as a ratio of the lumen, showing red, to the cell wall, showing black. The background in each image shows green. Fineness is determined as linear density. The weight of each sample is determined before placing the sample in the bowl of water. As the sample is stirred, using a magnetic stirrer, coarser samples will have fewer fibers present themselves to the imaging system. This principle is used to determine fineness.

The Cottonscope provides a more affordable (˜$40,000) measurement of fiber maturity and fineness. However, Cottonscope-based tests take up to 15 minutes after measurement. Moreover, Cottonscope-based tests require pre-treatment of fibers with water and a surfactant. Additionally, Cottonscope-based instruments are not portable.

Additional methods of assessing fiber quality rely on cross-sections and image analyses. Such methods take cross-sectional images from fibers set in a polymer resin. Sample preparation requires the sample be set in a series of resin encasements; a process that takes a considerable amount of time compared to the other methods mentioned. A thin slice of the sample is then presented to a microscope where a digital image is taken. The image of the sample cross-sections is then analyzed using image analysis software that determines features such as the fiber perimeter and the lumen area.

Even though cross-section images of fibers provide reference measurements, such methods do not quantify variation along the fiber. Moreover, such methods are slow (e.g., about 1 week per sample) and expensive. Additionally, sample preparation and validation of the image analysis routine require a highly skilled technician, which can introduce technician bias.

As such, a need exists for reliable, high-throughput, low-cost, automated and portable methods and systems for characterizing fiber properties, such as maturity and fineness. Numerous embodiments of the present disclosure aim to address the aforementioned need.

### Methods of Evaluating Fiber Quality

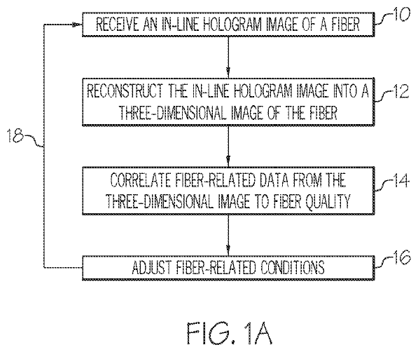

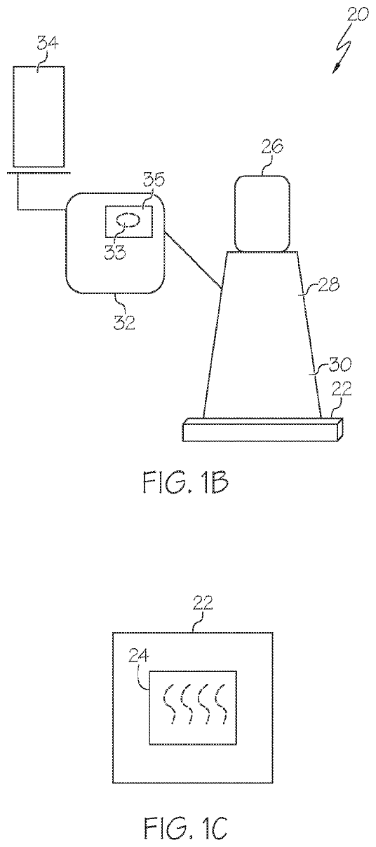

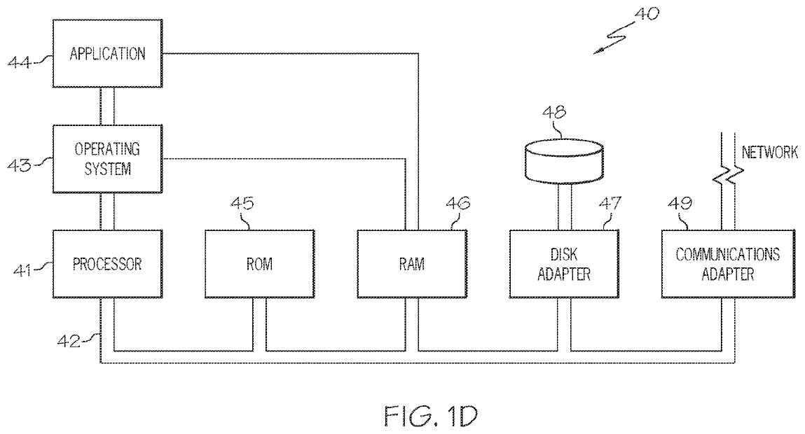

In some embodiments, the present disclosure pertains to computer-implemented methods of evaluating fiber quality. In some embodiments illustrated in FIG. 1A, the methods of the present disclosure include: receiving at least one in-line hologram image of the fiber (step 10); reconstructing the in-line hologram image of the fiber into at least one three-dimensional image of the fiber that includes fiber-related data (step 12); and correlating the fiber-related data to fiber quality (step 14). In some embodiments, the methods of the present disclosure also include adjusting fiber-related conditions (step 16) and repeating the steps after the adjustment (step 18). As set forth in more detail herein, the methods of the present disclosure can have various embodiments.

### Receiving In-Line Hologram Images of Fibers

The methods of the present disclosure may receive in-line hologram images of fibers in various manners. For instance, in some embodiments, the receiving includes receiving an in-line hologram image of a fiber from at least one image sensor. In some embodiments, the receiving includes receiving an in-line hologram image of a fiber from a plurality of image sensors. In some embodiments, the plurality of image sensors are positioned around the fiber. In some embodiments, signals from the plurality of image sensors are interpreted together in order to capture a larger in-line hologram image of a fiber.

In some embodiments, the methods of the present disclosure rely on receiving a single in-line hologram image of a fiber. In some embodiments, the methods of the present disclosure rely on receiving a plurality of in-line hologram images of a fiber.

In-line hologram images of fibers may be received from various surface areas. For instance, in some embodiments, in-line hologram images of a fiber are received from an area of more than about 1.5 mm². In some embodiments, in-line hologram images of a fiber are received from an area of more than about 2 mm². In some embodiments, in-line hologram images of a fiber are received from an area of more than about 5 mm². In some embodiments, in-line hologram images of a fiber are received from an area of more than about 10 mm².

In some embodiments, the methods of the present disclosure also include a step of generating an in-line hologram image of a fiber. In some embodiments, the generating occurs automatically. In some embodiments, an in-line hologram image of a fiber is generated from a lens-free holographic microscope. In some embodiments, the generating includes: irradiating a fiber with a light source; receiving an interference between light wave scattered from the fiber and the light source; and constructing an in-line holographic image of the fiber from the received interference.

### Reconstruction of Three-Dimensional Images of Fibers

Various methods may be utilized to reconstruct three-dimensional images of fibers from in-line holographic images. For instance, in some embodiments, the reconstruction occurs through the utilization of a software. In some embodiments, three-dimensional images of fibers may be reconstructed from a single interference pattern as the initial signal. The initial signal may then be processed by an algorithm into a series of layers that characterize the three-dimensional space occupied by the fibers.

In some embodiments, three-dimensional images of fibers may be reconstructed from in-line holographic images based on phase retrieved high-resolution holographic imaging and a three-dimensional deconvolution technique. In some embodiments, the three-dimensional image reconstruction, from low resolution to high resolution, is based on the conventional phase retrieval super-resolution and three-dimensional volumetric deconvolution approach to rebuilding a real object from the image plane. First, a super-resolution image is obtained using low-resolution subpixel movements and a phase retrieval algorithm. Second, a volumetric object is reconstructed using the three-dimensional volumetric convolution of the super-resolution hologram image, which acts as a spatial filter. Based on such an approach, a high-resolution three-dimensional volumetric image may be achieved.

The reconstructed three-dimensional images of fibers may include various fiber-related data. For instance, in some embodiments, the fiber-related data include amplitude data, phase data, and combinations thereof. In some embodiments, the fiber-related data include combined amplitude data and phase data.

In some embodiments, the fiber-related data include amplitude data. In some embodiments, the amplitude data represent optical scattering properties of the fiber.

In some embodiments, the fiber-related data include phase data. In some embodiments, the phase data represent a change in optical phase during light propagation through the fiber.

### Fibers

The methods of the present disclosure may be utilized to evaluate the quality of various types of fibers. For instance, in some embodiments, the fiber includes, without limitation, textile fibers, cotton fibers, hemp fibers, natural bast fibers, flax fibers, jute fibers, kenaf fibers, milkweed fibers, ramie fibers, artificial fibers, fiber bundles, fiber beards, and combinations thereof. In some embodiments, the fiber includes cotton fibers.

The fibers of the present disclosure may be evaluated in various forms. For instance, in some embodiments, the fiber is in the form of fiber bundles. In some embodiments, the fiber is in the form of fiber beards. In some embodiments, the fiber lacks any microfibers.

### Evaluated Fiber Qualities

The methods of the present disclosure may be utilized to evaluate various types of fiber qualities. For instance, in some embodiments, the fiber quality includes a physical feature of the fiber. In some embodiments, the fiber quality includes, without limitation, fiber maturity, fiber fineness, fiber convolutions, fiber length, amount of fiber lignin, amount of fiber cellulose, fiber roughness, fiber texture, fiber cell wall structure, fiber spiral structures, fiber contamination, fiber lumen area, internal structures of a fiber, and combinations thereof. In some embodiments, the fiber quality includes fiber maturity and fiber fineness.

In some embodiments, the fiber quality includes fiber maturity. In some embodiments, the fiber maturity is evaluated by measuring relative thickening of the fiber's secondary cell wall.

In some embodiments, the fiber quality includes fiber contamination. In some embodiments, the fiber contamination is evaluated by identifying particulates associated with the fiber. In some embodiments, the particulates include sugars.

In some embodiments, the methods of the present disclosure may be utilized to evaluate fiber convolutions. In some embodiments, the methods of the present disclosure evaluate fiber convolutions by evaluating the internal structures of a fiber. In some embodiments, the internal structures of a fiber also help identify secondary cell wall development needed to measure the fiber maturity. For instance, dead fibers that present a papery texture under conventional microscopy may also be differentiated in some embodiments.

### Correlation of Fiber-Related Data to Fiber Quality

Various methods may also be utilized to correlate fiber-related data from reconstructed three-dimensional images of fibers to fiber quality. For instance, in some embodiments, the correlating occurs manually through observations of the three-dimensional image.

In some embodiments, the correlating occurs automatically through the utilization of an algorithm. As such, in some embodiments, the methods of the present disclosure also include a step of feeding the fiber-related data into the algorithm to evaluate the fiber quality.

The methods of the present disclosure may utilize various types of algorithms to evaluate fiber quality. For instance, in some embodiments, the algorithm includes a machine-learning algorithm. In some embodiments, the machine-learning algorithm is trained to evaluate the fiber's quality.

In some embodiments, the machine-learning algorithm is an L1-regularized logistic regression algorithm. In some embodiments, the machine-learning algorithm includes supervised learning algorithms. In some embodiments, the supervised learning algorithms include nearest neighbor algorithms, naïve-Bayes algorithms, decision tree algorithms, linear regression algorithms, support vector machines, neural networks, convolutional neural networks, ensembles (e.g., random forests and gradient boosted decision trees), and combinations thereof. In some embodiments, the machine-learning algorithm includes, without limitation, Convolutional Neural Network (CNN) algorithms, Region-based CNN (R-CNN) algorithms, Fast R-CNN algorithms, rotated CNN algorithms, mask CNN algorithms, and combinations thereof.

Machine-learning algorithms may be trained to evaluate fiber quality from fiber-related data in various manners. For instance, in some embodiments, the training includes: (1) feeding a first set of measured fiber-related data correlated to a fiber quality into a machine-learning algorithm; (2) feeding a second set of measured fiber-related data correlated to the same fiber quality into the machine-learning algorithm; and (3) training the machine-learning algorithm to correlate the fiber-related data to the fiber quality by comparing the first set of measured fiber-related data with the second set of measured fiber-related data. In some embodiments, the first set of measured fiber-related data corresponds to the training data and the second set of measured fiber-related data corresponds to validation data. In this manner, the first set of measured fiber-related data is utilized for training, which is validated based on the second set of measured fiber-related data. In some embodiments, training of a machine-learning algorithm includes the adjustment of weights or parameters within the machine-learning algorithm so as to differentiate between the first and second set of fiber-related data.

In some embodiments, the machine-learning algorithm is associated with a graphical user interface (GUI) that is operational for training the machine-learning algorithm to evaluate the fiber quality. In some embodiments, the algorithm evaluates the fiber quality in a quantitative manner.

In some embodiments, the algorithm separately evaluates fiber maturity and fiber fineness. In some embodiments, a model (e.g., a machine-learning model) is built and trained to predict the quality of a fiber. In some embodiments, a machine learning algorithm (e.g., a supervised learning algorithm) is utilized to build the model to predict the quality of fiber using a sample data set containing historical information as to the quality of the fiber based on fiber-related data from the reconstructed three-dimensional images of the fibers, where such historical information may be provided by an expert.

Such a sample data set is referred to herein as the “training data,” which is used by the machine-learning algorithm to make predictions or decisions as to the predicted quality of the fiber. The machine-learning algorithm iteratively makes predictions on the training data as to the quality of the fiber until the predictions achieve the desired accuracy as determined by an expert. Examples of such machine-learning algorithms include nearest neighbor, Naïve Bayes, decision trees, linear regression, support vector machines and neural networks.

In some embodiments, fiber-related data and the associated evaluations of the fiber quality are stored in a data structure (e.g., a table). For instance, in some embodiments, the data structure may include a listing of one or more fiber-related conditions that are associated with various evaluations of the fiber quality. In some embodiments, such a data structure is populated by an expert. In some embodiments, such a data structure is stored in a storage device, such as memory 35 of system 20 in FIG. 1B.

### Adjustment of Fiber-Related Conditions

The methods of the present disclosure can include additional steps that utilize the evaluated fiber quality to further improve the quality of fibers. For instance, in some embodiments, the methods of the present disclosure also include a step of adjusting one or more fiber-related conditions based on the evaluation of the fiber quality. In some embodiments, the one or more fiber-related conditions include, without limitation, fiber growth conditions, fiber storage conditions, fiber milling conditions, fiber transport conditions, fiber breeding conditions, and combinations thereof.

In some embodiments, the one or more fiber-related conditions include one or more fiber growth conditions. In some embodiments, the one or more fiber growth conditions include, without limitation, herbicide levels, irrigation conditions, fertilizer levels, growth temperature, and combinations thereof.

### Systems for Evaluating Fiber Quality

Additional embodiments of the present disclosure pertain to systems for evaluating fiber quality. In some embodiments, the systems of the present disclosure are operational to evaluate fiber quality in accordance with the methods of the present disclosure. In some embodiments, the systems of the present disclosure are operational to generate at least one in-line hologram image of a fiber and reconstruct the in-line hologram image of the fiber into at least one three-dimensional image of the fiber that includes fiber-related data.

FIGS. 1B and 1C provide an illustration of a system of the present disclosure, which is depicted as system 20. In this Example, system 20 includes receiving area 22 with region 24 for housing a fiber; a light source 26 associated with the receiving area 22; a chamber 28 associated with light source 26 and receiving area 22; a camera 30 within chamber 28; a processor 32 in electrical communication with camera 30; a storage device 35 associated with processor 32; an algorithm 33 stored within storage device 35; and a graphical user interface (GUI) 34 associated with processor 32. In operation, a fiber to be evaluated is placed on region 24 of receiving area 22. Thereafter, receiving area 22 is coupled with chamber 28 and light source 26. Next, light source 26 is actuated to irradiate region 24 such that camera 30 records an interference between light wave scattered from the fiber and the light source. Thereafter, the recorded interference is transmitted to processor 32 for generation of an in-line hologram image of the fiber. Processor 32 then reconstructs the in-line hologram image of the fiber into a three-dimensional image of the fiber with fiber-related data. The fiber-related data from the three-dimensional image is then fed into algorithm 33 for the correlation of the fiber-related data to fiber quality. Graphical user interface (GUI) 34 may be utilized to assist in the evaluation of the fiber quality. Additionally, the fiber-related data may be stored in storage device 35.

The systems of the present disclosure may have various embodiments. For instance, in some embodiments, the light source of the systems of the present disclosure includes an LED light source. In some embodiments, the light source of the systems of the present disclosure includes a UV light source. In some embodiments, the coherence of the light source can help refine the appearance of cellulose and other macromolecules in a fiber. For instance, in some embodiments, different light sources may help differentiate fiber lignin and cellulose. In some embodiments, different light sources may help measure the total amount of cellulose.

In some embodiments, regions for housing a fiber during the generation of an in-line hologram may have various areas. For instance, in some embodiments, the region includes an area of more than about 1.5 mm². In some embodiments, region includes an area of more than about 2 mm². In some embodiments, the region includes an area of more than about 5 mm². In some embodiments, region includes an area of more than about 10 mm².

Additionally, regions for housing a fiber may be in various forms. For instance, in some embodiments, the region is in the form of an imaging chip.

The systems of the present disclosure may also include various types of cameras. For instance, in some embodiments, the cameras of the present disclosure include a lens-free holographic microscope. In some embodiments, the camera includes at least one image sensor. In some embodiments, the camera includes a plurality of image sensors. In some embodiments, the plurality of image sensors are positioned around a region housing a fiber. In some embodiments, the plurality of image sensors are positioned around a region housing a fiber in the form of an array. In some embodiments, the plurality of image sensors include sensors with different sizes.

In some embodiments, the systems of the present disclosure can be readily scaled because the sensors can be purchased in different sizes and they can be arranged in an array, where their signals are interpreted together in order to capture a larger single hologram. In some embodiments, the systems of the present disclosure include a series of larger hologram sensors that are arranged in an array in order to capture a hologram from a bundle of fibers, such as a fiber beard from an HVI.

The systems of the present disclosure may also include various types of algorithms for correlating fiber-related data to fiber quality. Suitable algorithms and methods of training them to evaluate fiber quality were described supra. For instance, in some embodiments, the algorithm includes a machine-learning algorithm that is trained to evaluate a fiber's quality. In some embodiments, the machine-learning algorithm includes, without limitation, Convolutional Neural Network (CNN) algorithms, Region-based CNN (R-CNN) algorithms, Fast R-CNN algorithms, rotated CNN algorithms, mask CNN algorithms, and combinations thereof.

The systems of the present disclosure may have various advantageous features. For instance, in some embodiments, the systems of the present disclosure are portable. In some embodiments, the systems of the present disclosure weigh less than 5 pounds. In some embodiments, the systems of the present disclosure weigh less than 1 pound.

### Computer Program Products

Additional embodiments of the present disclosure pertain to computer program products for evaluating fiber quality. In some embodiments, the computer program product includes one or more computer readable storage mediums having a program code embodied therewith, where the program code includes programming instructions for: receiving at least one in-line hologram image of the fiber; reconstructing the at least one in-line hologram image of the fiber into at least one three-dimensional image of the fiber with fiber-related data; and correlating the fiber-related data to fiber quality. In some embodiments, the program code also includes programming instructions for generating the in-line hologram image of the fiber.

In some embodiments, the fiber-related data of the three-dimensional image of the fiber includes amplitude data, phase data, and combinations thereof. In some embodiments, the fiber-related data includes combined amplitude data and phase data.

In some embodiments, the program code also includes an algorithm for the correlating. Suitable algorithms were described supra. For instance, in some embodiments, the algorithm includes a machine-learning algorithm. In some embodiments, the machine-learning algorithm is trained to evaluate the fiber's quality. In some embodiments, the machine-learning algorithm includes, without limitation, Convolutional Neural Network (CNN) algorithms, Region-based CNN (R-CNN) algorithms, Fast R-CNN algorithms, rotated CNN algorithms, mask CNN algorithms, and combinations thereof.

In some embodiments, the program code also includes programming instructions for adjusting one or more fiber-related conditions based on the evaluation. Suitable fiber-related conditions were described supra. For instance, in some embodiments, the one or more fiber-related conditions include, without limitation, fiber growth conditions, fiber storage conditions, fiber milling conditions, fiber transport conditions, fiber breeding conditions, and combinations thereof. In some embodiments, the program code also includes programming instructions for repeating the method after the adjusting.

The computer program products of the present disclosure can include various types of computer readable storage mediums. For instance, in some embodiments, the computer readable storage mediums can be a tangible device that can retain and store instructions for use by an instruction execution device. In some embodiments, the computer readable storage medium may include, without limitation, an electronic storage device, a magnetic storage device, an optical storage device, an electromagnetic storage device, a semiconductor storage device, and combinations thereof. A non-exhaustive list of more specific examples of suitable computer readable storage medium includes, without limitation, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and combinations thereof.

A computer readable storage medium, as used herein, is not to be construed as being transitory signals per se. Such transitory signals may be represented by radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein can be downloaded to respective computing/processing devices from a computer readable storage medium or to an external computer or external storage device via a network, such as the Internet, a local area network, a wide area network and/or a wireless network. In some embodiments, the network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, the computer readable program instructions may execute entirely on the user's computer, partly on the user's computer, as a stand-alone software package, partly on the user's computer and partly on a remote computer or entirely on the remote computer or server. In the latter scenario, the remote computer may be connected in some embodiments to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present disclosure.

The computer program products of the present disclosure may be operated in various manners. An example of the operation of the computer program products of the present disclosure is illustrated with reference to a flowchart in FIG. 1D, which illustrates the arrangement of an application 44, operating system 43, processor 41, ROM 45, RAM 46, disk adaptor 47, disk 48, communications adaptor 49, and network 42. It will be understood that each block of the flowchart illustrations and/or block diagrams, and combinations of blocks in the flowchart illustrations and/or block diagrams, can be implemented by computer readable program instructions.

The flowchart and block diagrams in FIG. 1D illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in FIG. 1D. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In some embodiments, these computer readable program instructions may be provided to a processor of a computer, or other programmable data processing apparatus to produce a machine, such that the instructions, which execute via the processor of the computer or other programmable data processing apparatus, create a system for implementing the functions/acts specified in the flowchart and/or block diagram block or blocks in FIG. 1D. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In some embodiments, the computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

### Applications and Advantages

The methods, systems and computer program products of the present disclosure provide numerous advantages. For instance, unlike conventional imaging techniques that have been widely used, the methods of the present disclosure provide in some embodiments a high imaging area (e.g., >10 mm²). Additionally, in some embodiments, reconstructed images of in-line hologram images can be computed from a single snapshot, thereby eliminating the need to continuously focus and capture images at different heights. Moreover, the imaging systems and programs of the present disclosure are very low cost (e.g., less than $200), thereby providing the ability to be utilized in a scaled-up manner. Furthermore, the imaging systems and programs of the present disclosure are compact and lightweight (e.g., less than 1 lb), thereby making them very portable for on-site measurements, such as in fields. Additionally, the coupling of machine-learning algorithms to the methods of the present disclosure can help enable automated identification and quantification of the morphological properties of cotton fibers in a high-throughput manner.

Accordingly, the systems, computer program products and methods of the present disclosure can have various applications. For instance, in some embodiments, the systems, computer program products and methods of the present disclosure can be utilized to assess the quality of various fibers (e.g., cotton fibers) in a fast, reliable, low cost and portable manner. Such applications may be highly relevant to the cotton industry because cotton fiber maturity and fineness have widespread implications in the marketability of cotton.

In some embodiments, the methods, computer program products and systems of the present disclosure can provide breeders a tool for directly assessing the maturity and fineness of their germplasm for a given plot, thereby providing farmers a way to manage their crop in order to maximize marketability. In some embodiments, the methods, computer program products and systems of the present disclosure can also be utilized to provide spinning mills a fast and accurate method for selecting bales and managing mill throughput.

In additional embodiments, research scientists may use the systems, computer program products and methods of the present disclosure to evaluate the effect of treatments, such as novel herbicides or irrigation, on the potential fiber quality characteristics of different cotton varieties. Such information could then be used, in some embodiments, by cotton producers to better manage their fields while targeting a more optimal fiber quality and garnering greater market premiums. In further embodiments, cotton spinning mills could use the methods, computer program products and systems of the present disclosure to evaluate bales of fiber purchased based on HVI properties, setting blends, and managing mill settings in such a way to minimize work stoppages and maximize yarn quality.

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. A Direct High-Throughput Method for Measuring Physical Features of Cotton Fibers

In this Example, Applicants demonstrate the development of a new high throughout method of evaluating fiber qualities from fiber bundles, such as fiber maturity and fineness, using a new imaging modality. The equipment needed to acquire the images is inexpensive and scalable, in that a system can be designed such that it works on larger bundles of fibers. The resulting images are data-rich and are analyzed for important morphological fiber properties using a deep learning algorithm and a custom graphical user interface (GUI).

Over the last few years, significant effort has been directed towards lens-free holographic microscopy, which can overcome the drawbacks of conventional imaging techniques, such as the trade-off between the imaging field of view and the resolution. These developments offer a potential method for direct measurement of fiber physical properties.

Lens-free holographic microscopy has previously been used for a wide range of applications related to imaging and sensing of viruses, bacteria, nanoparticles, rare cells, as well as characterization of polymer degradation, rheology and fluid analysis. In this Example, Applicants demonstrate the development of a lens free holographic microscope for high-throughput imaging of cotton fibers to quantify their fineness and maturity.

This microscope has a wide field of view, which enables three-dimensional imaging of a sample of cotton fibers in a bundle using a single snapshot and provides both phase and amplitude (i.e., scattering/absorption) information. The images are computationally obtained by backpropagating the in-line holograms, which result from the interference between the waves scattered from the cotton sample and directly transmitted waves to the sample plane. The holographic image reconstruction is performed using an automated code. Additionally, this microscope is low cost (˜$200) and thus the sample processing can be easily scaled up in a cost-effective manner by utilizing multiple such microscopes.

The resulting images are data rich. Accordingly, a deep learning architecture is implemented to identify the important morphological fiber features and automatically record them. A graphic user interface (GUI) is developed for training the neural network and processing the images.

### Example 1.1. The Imaging System

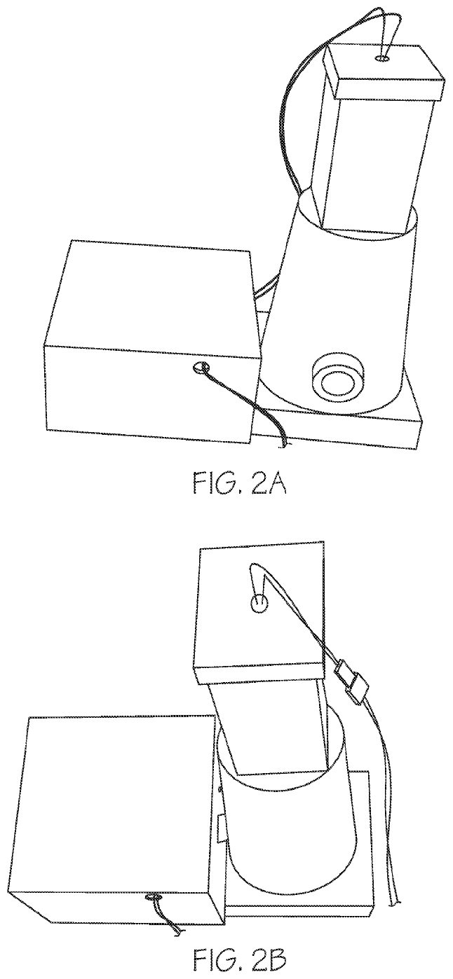

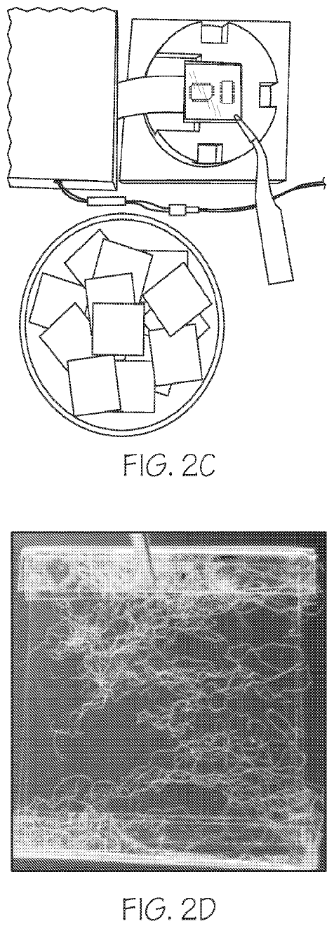

As illustrated in FIG. 2A, the imaging system in this Example is included of a three-dimensional (3D) printed housing to hold a complementary metal-oxide-semiconductor (CMOS) imager chip and a partially coherent illumination unit consisting of a pinhole and an optical band-pass filter.

The cotton fibers are irradiated from the top and the resulting interference patterns (i.e., in-line holograms) are formed due to the interference between the directly transmitted wave and the scattered wave from each cotton fiber. The interference are recorded in the CMOS imager chip and placed at sub mm distance from the sample plane.

Next, the 3D image stack is reconstructed by digitally back-propagating the hologram to the different (correct) object height (z₂) using an angular spectrum approach. Both the amplitude and phase information can be recovered using this approach.

This type of a lens free microscope enables high throughput measurements by enabling imaging and analysis over a wide area of more than 10 mm², which is more than ten times the field of view of a conventional microscope with a 10× objective). This would allow several centimeters of the fiber to be imaged at a time. Additional advantages of this technique are cost-effectiveness and portability to any location.

### Example 1.2. The Operating Steps of the Microscope

Proposed steps of operating the microscope include: (1) removing the illumination unit (FIG. 2B); (2) placing the cotton sample on the bare imaging chip (FIGS. 2C and 2D); (3) placing back the illumination unit; (4) connecting the power supply, any monitor, mouse and keyboard to the on-board processor in the microscope, even though the device can also be designed to be controlled using a smartphone (FIG. 2E); (5) turning on the LED light of the device (FIG. 2F); and (6) running the python program to start capturing the images.

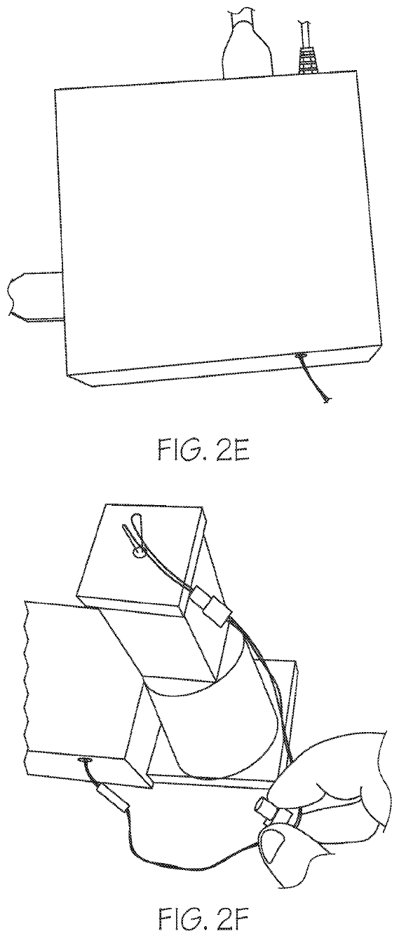

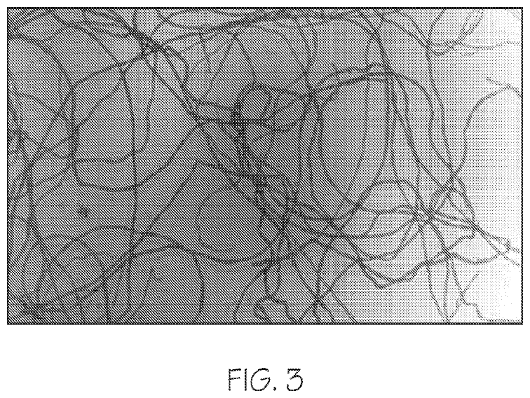

The captured images are called in-line holograms. They result from the interference between the light wave scattered from the cotton and the transmitted wave. An example of a captured image is illustrated in FIG. 3.

### Example 1.3. Reconstruction of In-Line Holograms

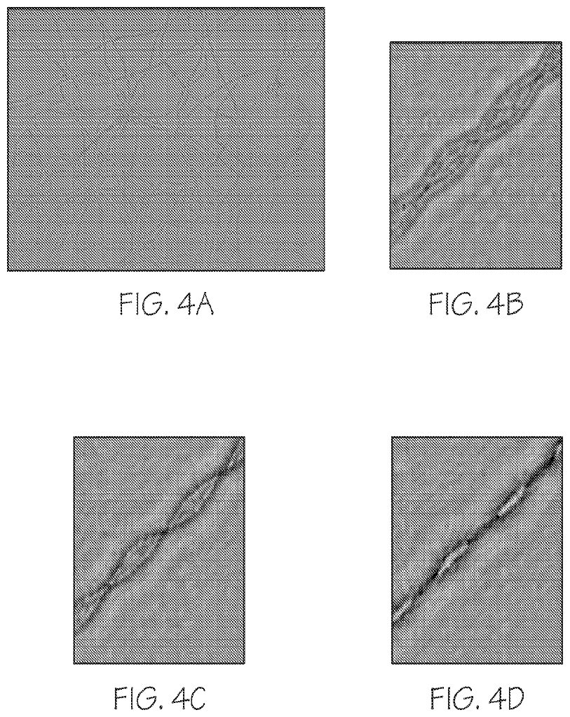

Next, the in-line holograms are reconstructed to obtain amplitude and phase images (FIGS. 4A-D). The amplitude reconstruction reflects the optical scattering properties of the fibers, whereas the phase reconstructed images indicate the change in optical phase as light propagates through the cotton fibers. Applicants observed that the features of the fiber are more prominent in the phase reconstructed images. Using this modality, Applicants were able to generate 3D stack of images of the cotton fiber.

### Example 1.4. Algorithm Training

Image labeling and training of the deep learning algorithm is performed using a GUI “Holo Video Labeler.” The “Holo Video Labeler” is a Matlab-based tool developed for use in this project in order to manually annotate the observed features (e.g., twists) of cotton fibers imaged with a digital holography microscope. The annotated features are used to train a deep learner that can detect the same features in previously unseen fibers automatically. This tool was developed to streamline the essential process of training data generation and to minimize inter-annotator variability.

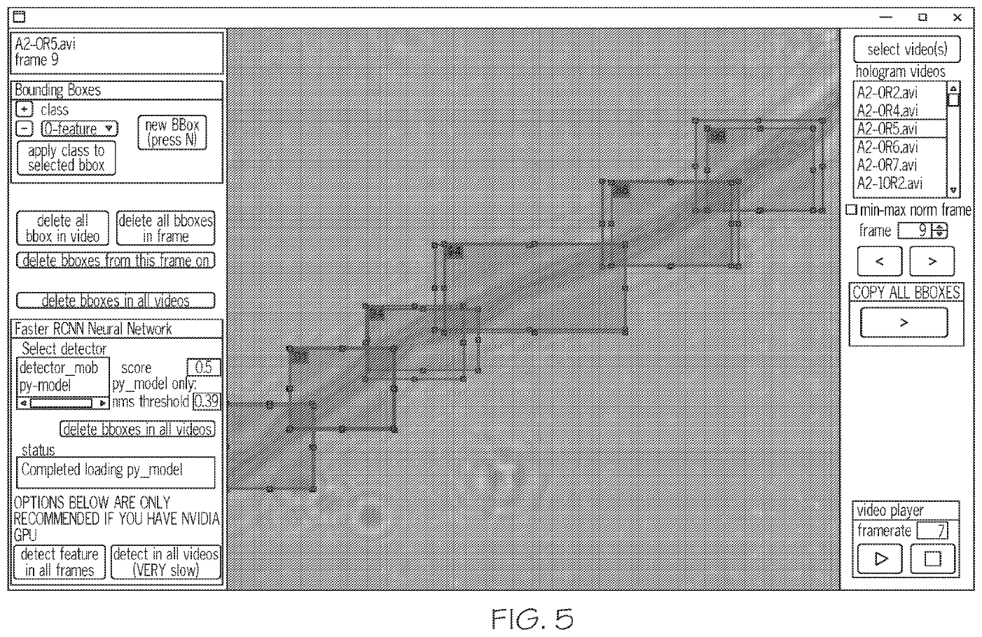

The capability of this tool was extended to include the results of the detection from the deep learner. Specifically, features from the training videos were used to train a faster-RCNN network (FIG. 5). The trained network can be invoked from the tool and its detections can be observed together with those from the manual annotation. This allows for a symbiotic interaction between the deep leaner and the annotator that is aimed to qualitatively assess and ultimately improve the learner's performance. Quantitative assessment of the network's efficacy is also possible.

### Example 1.5. Image Observations

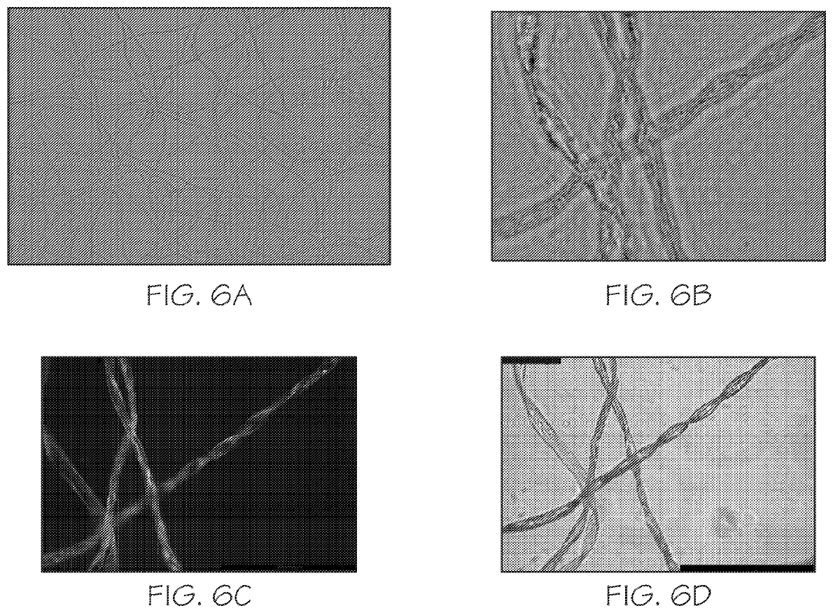

The different features observed in the phase images, such as the twists and thicker outer edges (kidney bean structure), were validated using a conventional microscope (FIGS. 6A-6D). Validation eliminates the possibility of any artifact that may be present due to the reconstruction process. This validation was done by first imaging the fibers using the holographic microscope to generate holograms, and then generating phase reconstructed images at different heights. The same area of the fibers was then imaged using two different modalities (i.e., phase contrast and dark field) to validate the observations recorded from the phase-reconstructed images.

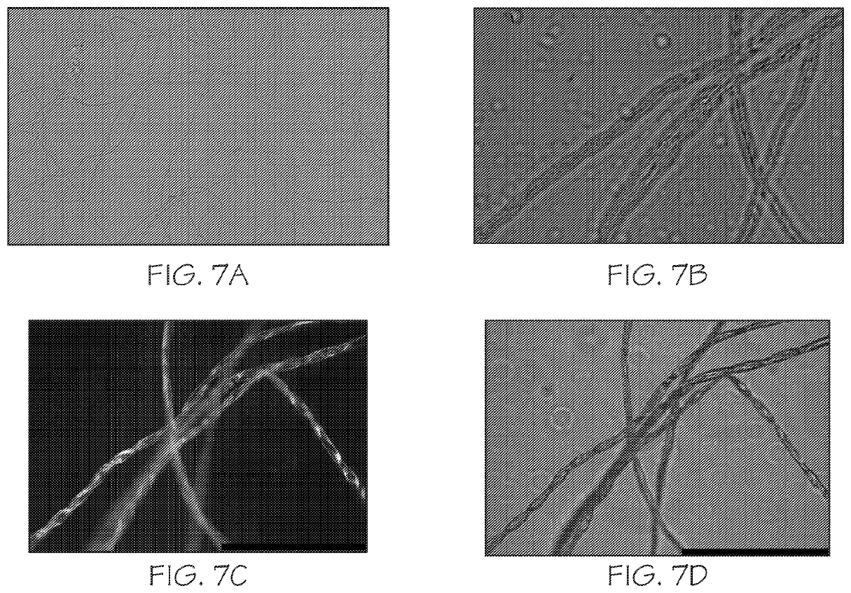

Three different cotton samples with varying maturity were imaged and the phase images were reconstructed at different heights (FIGS. 7A-7D). Applicants also validated these reconstructions using conventional microscopy.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A computer-implemented method of evaluating fiber quality, said method comprising:
receiving at least one in-line hologram image of the fiber;
reconstructing the at least one in-line hologram image of the fiber into at least one three-dimensional image of the fiber, wherein the at least one three-dimensional image of the fiber comprises fiber-related data; and
correlating the fiber-related data to fiber quality.

2. (canceled)

3. The method of claim 1, wherein the receiving comprises receiving a plurality of in-line hologram images of the fiber.

4. (canceled)

5. The method of claim 1, wherein the receiving comprises receiving at least one in-line hologram image of the fiber from a plurality of image sensors, wherein the plurality of image sensors are positioned around the fiber.

6. The method of claim 1, wherein the receiving comprises receiving the at least one in-line hologram image of the fiber from an area of more than about 5 mm².

7. (canceled)

8. The method of claim 1, further comprising a step of generating the at least one in-line hologram mage of the fiber, wherein the generating comprises:
irradiating the fiber with a light source;
receiving an interference between light wave scattered from the fiber and the light source; and
constructing the at least one in-line holographic image of the fiber from the received interference.

9. The method of claim 8, wherein the at least one in-line hologram image of the fiber is generated from a lens-free holographic microscope.

10. (canceled)

11. The method of claim 1, wherein the fiber-related data is selected from the group consisting of amplitude data, phase data, combined amplitude data and phase data, and combinations thereof.

12. (canceled)

13. The method of claim 1, wherein the fiber is selected from the group consisting of textile fibers, cotton fibers, hemp fibers, natural bast fibers, flax fibers, jute fibers, kenaf fibers, milkweed fibers, ramie fibers, artificial fibers, fiber bundles, fiber beards, and combinations thereof.

14. (canceled)

15. The method of claim 1, wherein the fiber quality is selected from the group consisting of fiber maturity, fiber fineness, fiber convolutions, fiber length, amount of fiber lignin, amount of fiber cellulose, fiber roughness, fiber texture, fiber cell wall structure, fiber spiral structures, fiber contamination, fiber lumen area, internal structures of a fiber, and combinations thereof.

16. (canceled)

17. The method of claim 1, wherein the fiber quality comprises fiber maturity, wherein the fiber maturity is evaluated by measuring relative thickening of the fiber's secondary cell wall.

18. The method of claim 1, wherein the fiber quality comprises fiber contamination, wherein the fiber contamination is evaluated by identifying particulates associated with the fiber.

19. The method of claim 1, wherein the correlating occurs manually.

20. The method of claim 1, wherein the correlating occurs automatically through the utilization of an algorithm, wherein the method further comprises feeding the fiber-related data into the algorithm, and wherein the algorithm evaluates the fiber quality.

21. (canceled)

22. The method of claim 20, wherein the algorithm comprises a machine-learning algorithm, wherein the machine-learning algorithm is trained to evaluate the fiber's quality, and wherein the machine-learning algorithm is selected from the group consisting of Convolutional Neural Network (CNN) algorithms, Region-based CNN (R-CNN) algorithms, Fast R-CNN algorithms, rotated CNN algorithms, mask CNN algorithms, and combinations thereof.

23. (canceled)

24. The method of claim 22, wherein the machine-learning algorithm is associated with a graphical user interface (GUI) operational for training the machine-learning algorithm to evaluate the fiber quality.

25. The method of claim 22, wherein the machine-learning algorithm separately evaluates fiber maturity and fiber fineness.

26. The method of claim 1, further comprising a step of adjusting one or more fiber-related conditions based on the evaluation, wherein the one or more fiber-related conditions are selected from the group consisting of fiber growth conditions, fiber storage conditions, fiber milling conditions, fiber transport conditions, fiber breeding conditions, and combinations thereof.

27. (canceled)

28. The method of claim 26, wherein the one or more fiber-related conditions comprise one or more fiber growth conditions.

29. The method of claim 28, wherein the one or more fiber growth conditions are selected from the group consisting of herbicide levels, irrigation conditions, fertilizer levels, growth temperature, and combinations thereof.

30. The method of claim 26, further comprising repeating the method after the adjusting.

31. A system for evaluating fiber quality, wherein the system is operational to generate at least one in-line hologram image of the fiber and reconstruct the at least one in-line hologram image of the fiber into at least one three-dimensional image of the fiber, wherein the at least one three-dimensional image of the fiber comprises fiber-related data, and wherein the system comprises:
a receiving area, wherein the receiving area comprises a region for housing the fiber during the generation of the at least one in-line hologram image of the fiber;
a light source associated with the receiving area, wherein the light source is operational to irradiate the region housing the fiber such that the system receives an interference between light wave scattered from the fiber and the light source for construction of the at least one in-line holographic image of the fiber;
a camera operational for recording the interference between light wave scattered from the fiber and the light source;
a processor in electrical communication with the camera and operational to generate the at least one in-line hologram image of the fiber and reconstruct the at least one in-line hologram image of the fiber into the at least one three-dimensional image of the fiber;
a storage device; and
an algorithm stored within the storage device, wherein the algorithm is operational to correlate the fiber-related data to fiber quality.

32. The system of claim 31, wherein the camera comprises a lens-free holographic microscope.

33. The system of claim 31, wherein the camera comprises a plurality of image sensors, wherein the plurality of image sensors are positioned around the region housing the fiber.

34. The system of claim 31, wherein the light source comprises an LED light source.

35. The system of claim 31, wherein the region housing the fiber comprises an area of more than about 5 mm².

36. (canceled)

37. The system of claim 31, wherein the system further comprises a chamber associated with the light source and the receiving area, wherein the chamber houses the camera, and wherein the chamber is operational to facilitate the interference between light wave scattered from the fiber and the light source for construction of the at least one in-line holographic image of the fiber.

38. The system of claim 31, wherein the system further comprises a graphical user interface (GUI), wherein the GUI is operational to evaluate the fiber quality.

39. The system of claim 31, wherein the algorithm comprises a machine-learning algorithm, wherein the machine-learning algorithm is trained to evaluate the fiber's quality, and wherein the machine-learning algorithm is selected from the group consisting of Convolutional Neural Network (CNN) algorithms, Region-based CNN (R-CNN) algorithms, Fast R-CNN algorithms, rotated CNN algorithms, mask CNN algorithms, and combinations thereof.

40. (canceled)

41. (canceled)

42. A computer program product for evaluating fiber quality, wherein the computer program product comprises one or more computer readable storage mediums having a program code embodied therewith, wherein the program code comprises programming instructions for:
receiving at least one in-line hologram image of the fiber;
reconstructing the at least one in-line hologram image of the fiber into at least one three-dimensional image of the fiber, wherein the at least one three-dimensional image of the fiber comprises fiber-related data; and
correlating the fiber-related data to fiber quality.

43. The computer program product of claim 43, wherein the program code further comprises the programming instructions for generating the at least one in-line hologram mage of the fiber.

44. The computer program product of claim 43, wherein the fiber-related data is selected from the group consisting of amplitude data, phase data, combined amplitude data and phase data, and combinations thereof.

45. (canceled)

46. The computer program product of claim 43, wherein the program code further comprises an algorithm for the correlating.

47. The computer program product of claim 46, wherein the algorithm comprises a machine-learning algorithm, wherein the machine-learning algorithm is trained to evaluate the fiber's quality, and wherein the machine-learning algorithm is selected from the group consisting of Convolutional Neural Network (CNN) algorithms, Region-based CNN (R-CNN) algorithms, Fast R-CNN algorithms, rotated CNN algorithms, mask CNN algorithms, and combinations thereof.

48. (canceled)

49. The computer program product of claim 43, wherein the program code further comprises the programming instructions for adjusting one or more fiber-related conditions based on the evaluation, wherein the one or more fiber-related conditions are selected from the group consisting of fiber growth conditions, fiber storage conditions, fiber milling conditions, fiber transport conditions, fiber breeding conditions, and combinations thereof.

50. (canceled)

51. The computer program product of claim 49, wherein the program code further comprises the programming instructions for repeating the method after the adjusting.
